(19) United States
(12) Patent Application Publication
(10) Pub. No.: US 2007/0230701 A1
(43) Pub. Date: Oct. 4, 2007

(54) CHAOTIC SIGNAL TRANSMITTER USING PULSE SHAPING METHOD

(75) Inventors: Sang Gyu PARK, GYUNGGI-DO (KR); Hyung Chul PARK, DAEJEON (KR); Chang Soo YANG, GYUNGGI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/689,907

(22) Filed: Mar. 22, 2007

(30) Foreign Application Priority Data
Mar. 28, 2006 (KR) 10-2006-0028085

(51) Int. Cl. H04L 9/00

(52) U.S. Cl. 380/263

(57) ABSTRACT

The invention relates to a chaotic signal transmitter using a pulse shaping method to amplitude-modulate a chaotic signal according to a transmission signal, thereby transmitting the chaotic signal having various slopes. The chaotic signal transmitter includes a waveform converter for blocking high frequency component of the transmission signal to convert the waveform of the transmission signal and a chaotic signal generator for generating the chaotic signal. The chaotic signal transmitter further includes a modulator for amplitude-modulating the chaotic signal according to the waveform-converted transmission signal.

### CLAIM OF PRIORITY

This application claims the benefit of Korean Patent Application No. 2006-0028085 filed on Mar. 28, 2006, in the Korean Intellectual Property Office, the disclosure of which is incorporated herein by reference.

### BACKGROUND OF THE INVENTION

1. Field of the Invention

The present invention relates to a chaotic signal transmitter and, more particularly, to a chaotic signal transmitter using a pulse shaping method to amplitude-modulate a chaotic signal according to a waveform-converted transmission signal, thereby transmitting a chaotic signal having various slopes.

2. Description of the Related Art

In general, a chaotic signal is characterized as an a periodic signal with no particular phase, and a wide band signal. A typical periodic signal has a regular phase in accordance with time and thus may be distorted or cancelled when an interference signal of an antiphase is added. However, a chaotic signal has no clear phase so that it does not interfere with any antiphase signals or interference signals introduced thereto, thus protecting a data signal containing information. Also, in terms of frequency analysis, the chaotic signal has superior energy efficiency since it has a regulated magnitude irrespective of a period in a wide band.

Such a chaotic signal can be used as a carrier wave suitable for information transmission. This eliminates a need for a separate coding such as time hopping in a modem due to fewer spikes, allowing a simple configuration of transmitter or receiver using a simple modulation method of On-Off Keying (OOK).

In the meantime, according to a conventional modulation method using the chaotic signal, a signal can be transmitted using a bandwidth of 10 to 20% of carrier frequency, in principle. But such a typical modulation method requires complex technical interpretation for the original signal during demodulation.

Despite such drawbacks, using the chaotic signal ensures a controlled use through a small change in the system, thereby achieving a communication system with improved power efficiency. Moreover, the chaotic signal fundamentally has a continuous spectrum that expands into a wider frequency band, thus applicable to modulation without any loss of energy spectrum throughout the wide band. Therefore, with such merits, there have been attempts to apply a chaotic signal to a transmitter or a receiver that uses an ultra-wide band.

FIG. 1 is a block diagram illustrating a conventional chaotic signal transmitter.

Referring to FIG. 1, the conventional chaotic signal transmitter includes a chaotic signal generator 10 for generating a chaotic signal, a modulator 20 for modulating the chaotic signal from the chaotic signal generator 10 and an amplifier 30 for amplifying the chaotic signal modulated by the modulator 20.

The modulator 20 modulates the chaotic signal from the chaotic signal generator 10 by OOK according to transmission data a user desires to transmit.

The amplifier 30 amplifies the chaotic signal modulated by the modulator 20 into a predetermined magnitude and transmits the amplified signal through an antenna.

The transmission data desired to be transmitted by the user is transformed into a transmission signal. The transmission signal uses a square wave in the form of a pulse. For example, in a case where the transmission signal is ‘101101’, and when ‘1’ is received, the modulator 20 switches ‘on’ the chaotic signal from the chaotic signal generator 10 so as to output the chaotic signal. When ‘0’ is received, the modulator 20 switches ‘off’ the chaotic signal so as not to output the chaotic signal. This allows the chaotic signal to be modulated by OOK in accordance with the transmission signal. The chaotic signal modulated according to the transmission signal is amplified by the amplifier 30 and transmitted. The reception result of the modulated chaotic signal by a receiver will now be explained with reference to FIG. 2.

FIG. 2 is a graph illustrating an example of a correlation result of a signal received from a conventional ultra-wide band transceiver using chaotic signal.

Referring to FIG. 2, the graph represents the correlation result received by the receiver when the transmission signal is for example ‘101101’. The lowest point A1 of the graph represents ‘0’ and the highest point B1 of the graph represents ‘1’. In addition, C1 denotes a slope from the lowest point A1 to the highest point B1. Since the transmission data is a square wave, the waveform received by the receiver composed of an envelope detector and the correlator is a triangle wave or a continuation of triangle waves.

In the meantime, in an ultra-wide band transmitter, the distance between a transmitter and a receiver is measured by correlating a signal transmitted from the transmitter at the receiver, sensing the time taken from the lowest point to the highest point from the correlation result, and transmitting the sensed time to the transmitter. From the correlation result of the received signal, the receiver determines the highest point according to the change in the slope from the lowest point to the highest point. Such distance measurement is an important factor directly related to efficiency in adjusting the power used in transmission according to the distance.

However, as shown in the graph of FIG. 2, in the conventional ultra-wide band transmitter, almost no change is exhibited in the slope C1 from the lowest point A1 to the highest point B1, which makes it difficult to determine the highest point B1. This in turn makes it difficult for the receiver to accurately sense the time taken from the lowest point A1 to the highest point B1, hindering precise distance measurement. Therefore, since the distance between the transmitter and the receiver is not measured precisely, excessive transmission power is used to transmit the signal, degrading transmission power efficiency.

### SUMMARY OF THE INVENTION

The present invention has been made to solve the foregoing problems of the prior art and therefore an aspect of the present invention is to provide a chaotic signal transmitter which does not use On-Off Keying (OOK) but amplitude-modulates a chaotic signal according to a waveform-transformed transmission signal, enabling precise distance measurement between the transmitter and a receiver.

Another aspect of the invention is to provide a chaotic signal transmitter which uses only a necessary amount of transmission power through precise distance measurement between the transmitter and a receiver, thereby improving transmission power efficiency.

According to an aspect of the invention, the invention provides a chaotic signal transmitter using a pulse shaping method to enable precise distance measurement between a receiver and the transmitter. The chaotic signal transmitter includes: a waveform converter for converting the waveform of a transmission signal; a chaotic signal generator for generating a chaotic signal; and a modulator for amplitude-modulating the chaotic signal from the chaotic signal generator according to the waveform-converted transmission signal from the waveform converter.

In addition, the chaotic signal transmitter according to the present invention further includes: a band pass filter for passing the chaotic signal modulated by the modulator through a predetermined band; and an amplifier for amplifying the band-passed chaotic signal from the band pass filter into a predetermined magnitude.

According to the present invention, the modulator may be composed of a mixer for mixing the transmission signal waveform-converted by the waveform converter and the chaotic signal from the chaotic signal generator to amplitude-modulate the chaotic signal.

Further, according to the present invention, the waveform converter can block a high frequency component of the transmission signal to convert the waveform of the transmission signal, and the waveform converter may be composed of a low pass filter.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a conventional chaotic signal transmitter;

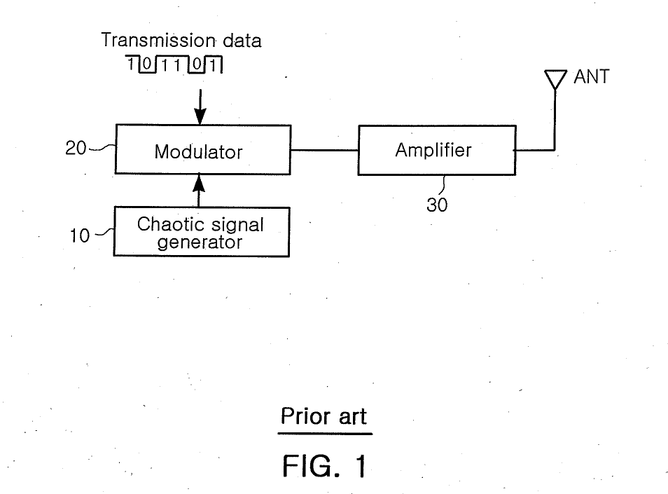

FIG. 2 is a graph illustrating an example of correlation result of a chaotic signal received from the conventional chaotic signal transmitter;

FIG. 3 is a block diagram illustrating a chaotic signal transmitter according to the present invention;

FIG. 4 is a graph illustrating an example of signal modulation process of the chaotic signal transmitter according to the present invention; and

FIG. 5 is a graph illustrating an example of correlation result of the chaotic signal received from the chaotic signal transmitter according to the present invention.

### DETAILED DESCRIPTION OF THE PREFERRED EMBODIMENT

Exemplary embodiments of the present invention will now be described in detail with reference to the accompanying drawings.

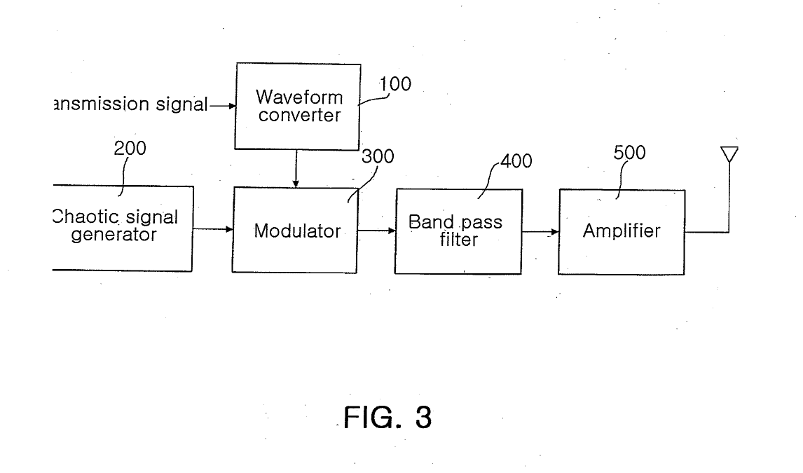

FIG. 3 is a block diagram illustrating a chaotic signal transmitter according to the present invention.

Referring to FIG. 3, the chaotic signal transmitter according to the present invention includes a waveform converter 100 for converting the waveform of a transmission signal, a chaotic signal generator 200 for generating a chaotic signal and a modulator 300 for modulating the chaotic signal from the chaotic signal generator 200 according to the transmission signal from the waveform converter 100.

First, there is transmission data a user desires to transmit. The transmission data is made up of ‘0’ and ‘1’. The transmission data is transformed into a transmission signal. Preferably, the transmission signal may be a square wave pulse.

The waveform converter 100 converts the waveform of the transmission signal. That is, the waveform converter 100 may be composed of a pulse shaping filter which converts the waveform of the transmission signal. A pulse shaping filter is a type of low pass filter which blocks a high frequency component of the transmission signal while passing a low frequency component. In a case where the transmission signal is a square wave, the low frequency band of the transmission signal of a square wave is passed by the waveform converter 100, and thereby the transmission signal is converted into a transmission signal of a polynomial function having a similar form as a sine wave. Then, the waveform-converted transmission signal is transmitted to the modulator 300.

The chaotic signal generator 200 generates a chaotic signal and supplies the chaotic signal to the modulator 300. The chaotic signal is a signal having energy without a particular phase. On the other hand, the transmission signal has only a magnitude but not energy necessary for transmission. Therefore, the chaotic signal provides an energy source needed for transmission of the transmission signal. That is, the chaotic signal is modulated according to the transmission signal of low frequency component passed through the low pass filter. The chaotic signal is modulated by the modulator 300.

The modulator 300 amplitude-modulates the chaotic signal from the chaotic signal generator 200 according to the waveform-converted transmission signal from the waveform converter 100. Preferably, the modulator 300 may be composed of a mixer which mixes the waveform-converted transmission signal from the waveform converter 100 and the chaotic signal from the chaotic signal generator 200 to amplitude-modulate the chaotic signal according to the waveform-converted transmission signal.

The mixer constituting the modulator 300 uses the sum of and difference between the frequency of the waveform-converted transmission signal and the frequency of the chaotic signal to mix the waveform-converted transmission signal and the chaotic signal, thereby amplitude-modulating the chaotic signal according to the waveform-converted transmission signal.

For example, if the frequency of the transmission signal is 1 MHz, and the frequency band of the chaotic signal is 3.0 GHz to 5.0 GHz, the amplitude-modulated chaotic signal by the mixer constituting the modulator 300 has a frequency band of 2.999 GHz to 5.001 GHz, and has an amplitude according to the amplitude of the transmission signal.

The chaotic signal has a frequency band of a wide band. Therefore, it is preferable that the mixer constituting the modulator 300 has frequency characteristics of a wide band.

The chaotic signal transmitter according to the present invention may further include a band pass filter 400 and an amplifier 500.

The band pass filter 400 passes a signal of a predetermined band out of the chaotic signal from the modulator 300. The chaotic signal is a signal that has no particular phase but has a plurality of phases mixed with each other to include various frequency components. In addition, the modulator 300 is composed of a mixer to mix the transmission signal of low frequency component and the chaotic signal, thereby amplitude-modulating the chaotic signal. At this time, undesired noise such as unnecessary high frequency component of the transmission signal and the chaotic signal may be produced. Therefore, the band pass filter 400 passes the modulated chaotic signal through a predetermined band to block unnecessary frequency band and undesired noise in the modulated chaotic signal, thereby providing a chaotic signal of a desired frequency band.

The amplifier 500 amplifies the band-passed chaotic signal by the band pass filter 400 into a predetermined magnitude to transmit the amplified signal. The chaotic signal has a predetermined magnitude but if transmitted on the air, the magnitude of the chaotic signal gradually decreases as the transmission distance increases. Therefore, the amplifier 500 amplifies the chaotic signal into a magnitude sufficient for transmission into atmosphere through an antenna.

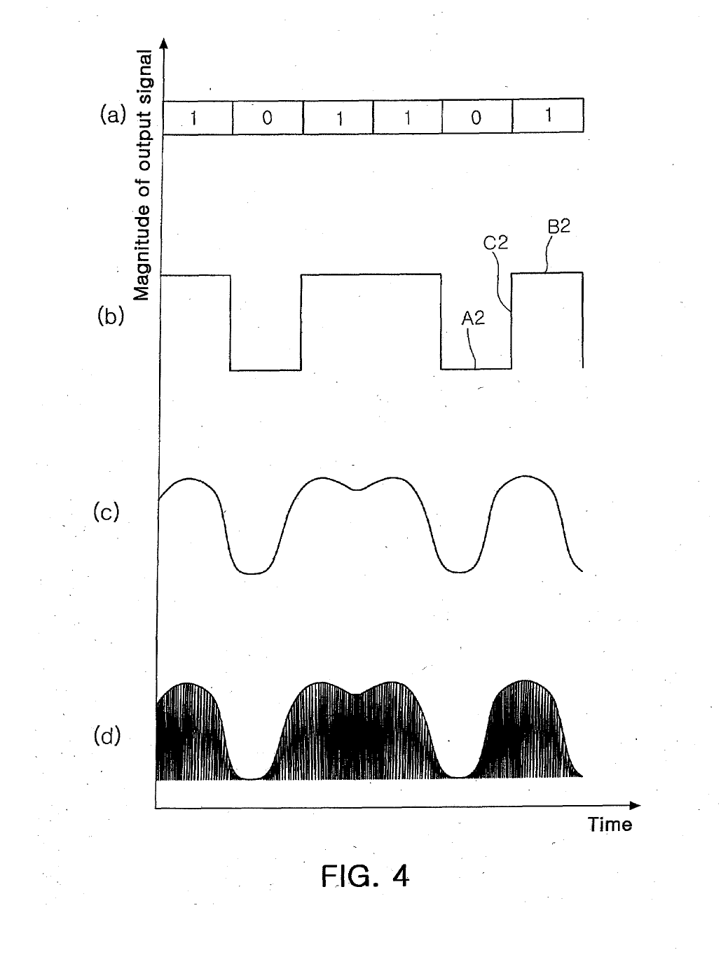

FIG. 4(a) to (d) is a graph illustrating an example of a signal modulation process of the chaotic signal transmitter according to the present invention.

In FIG. 4, the horizontal axis represents time and the vertical axis represents magnitude of output signal.

FIG. 4(a) represents transmission data a user desires to transmit and FIG. 4(b) represents a transmission signal of a square wave, transformed from the transmission data.

The transmission signal of a square wave is waveform-converted by the waveform converter 100. The waveform converter 100 passes the low frequency band of the waveform-converted transmission signal. As a result, the waveform-converted transmission signal can be represented by a transmission signal having a waveform similar to a sine wave as shown in FIG. 4(c).

FIG. 4(d) represents the chaotic signal amplitude-modulated according to the waveform-converted transmission signal by the modulator 300.

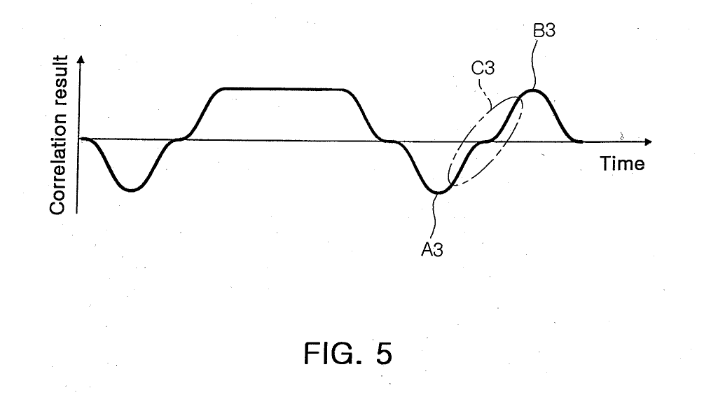

FIG. 5 is a graph illustrating an example of a correlation result of the chaotic signal received from the chaotic signal transmitter according to the present invention.

In the graph of FIG. 5, the horizontal axis represents time and the vertical axis represents the correlation result.

The correlation result is exhibited in accordance with time as the modulated chaotic signal is received by the receiver and processed by an envelope detector and a correlator of the receiver.

Now, the operation and effects of the present invention will be explained with reference to accompanying drawings.

Referring to FIGS. 3 and 4(a) to (d), first, there is transmission data a user desires to transmit. As shown in FIG. 4(a), for example, if the transmission data is ‘101101’, a transmission signal transformed from such transmission data can be a transmission signal of a square wave as shown in FIG. 4(b).

The transmission signal of a square wave is waveform-converted by the waveform converter 100. Referring to FIG. 4(c), the transmission signal with its low frequency band passed and thereby waveform-converted by the waveform converter 100 can be represented as a transmission signal having a waveform similar to a sine wave.

The modulator 300 amplitude-modulates the chaotic signal from the chaotic signal generator 200 in accordance with the waveform-converted transmission signal. The modulator 300 is composed of a mixer to mix the waveform-converted transmission signal and the chaotic signal, thereby amplitude-modulating the chaotic signal according to the low frequency-passed transmission signal. The amplitude-modulated chaotic signal is as shown in FIG. 4(d).

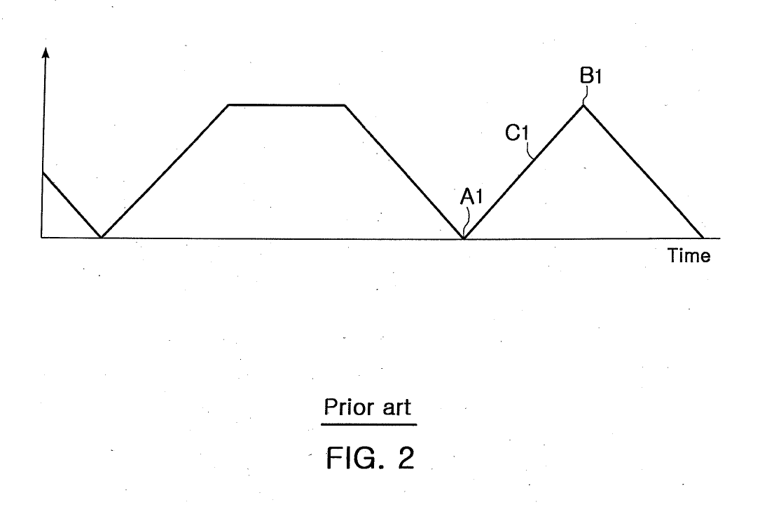

Referring to FIGS. 2 to 5, A2 and B2 of FIG. 4(b) represent the lowest point A2 and the highest point B2 of the transmission signal of a square wave, respectively, and C2 represents a slope of the section from the lowest point A2 to the highest point B2.

Referring to FIG. 4(b), it can be seen that there is no change in the slope C2 of the section leading to the highest point B2 of the transmission signal.

The chaotic signal transmitter according to the present invention waveform-converts the transmission signal, modulates the waveform-converted chaotic signal according to the waveform-converted transmission signal and transmits the modulated signal. The correlation result of the chaotic signal transmitted to the receiver is as shown in FIG. 5.

C3 in FIG. 5 represents a slope of the section from the lowest point A3 to the highest point B3. Examining the correlation result with respect to the receiver of the chaotic signal amplitude-modulated according to the transmission signal of low frequency band passed through the low pass filter, changes are noticed in the slope of the section leading to the highest point B3 as indicated by C3.

That is, comparing C3 of FIG. 5 and C1 of FIG. 2, the slope C1 of the section from the lowest point A1 to the highest point B1 of the chaotic signal modulated by the conventional transmitter is a line without any changes, whereas the slope C3 of the section leading to the highest point B3 of the chaotic signal modulated according to the transmitter of the present invention exhibits various changes.

The chaotic signal modulated by the conventional transmitter has no changes in the slope reaching the highest point, and thus the receiver is able to determine the highest point B1 only after the chaotic signal reaches the highest point B1.

On the other hand, the chaotic signal modulated according to the transmitter of the present invention exhibits changes in the slope reaching the highest point, and thus the transmitter is able to sense the changes in the slope C3 and thereby predicts the highest point B3 beforehand. This allows the transmitter to accurately determine the highest point of the modulated chaotic signal. Therefore, the transmitter is able to sense the time taken from the lowest point to the highest point of the modulated chaotic signal, enabling precise distance measurement between the transmitter and the receiver.

As described above, a chaotic signal is amplitude-modulated according to a waveform-converted transmission signal to have various changes in a slope reaching the highest point of the modulated chaotic signal, thereby allowing precise distance measurement between a transmitter and a receiver. Furthermore, since the distance is precisely measured between the transmitter and the receiver, only the amount of power necessary for signal transmission is used to efficiently regulate the transmission power.

While the present invention has been shown and described in connection with the exemplary embodiments, it will be apparent to those skilled in the art that modifications and variations can be made without departing from the spirit and scope of the invention as defined by the appended claims.

What is claimed is:

1. A chaotic signal transmitter using a pulse shaping method to enable precise distance measurement between a receiver and the transmitter, comprising:
a waveform converter for converting the waveform of a transmission signal;
a chaotic signal generator for generating a chaotic signal; and
a modulator for amplitude-modulating the chaotic signal from the chaotic signal generator according to the waveform-converted transmission signal from the waveform converter.

2. The chaotic signal transmitter according to claim 1, further comprising:
a band pass filter for passing the chaotic signal modulated by the modulator through a predetermined band; and
an amplifier for amplifying the band-passed chaotic signal from the band pass filter into a predetermined magnitude.

3. The chaotic signal transmitter according to claim 1, wherein the modulator comprises a mixer for mixing the transmission signal waveform-converted by the waveform converter and the chaotic signal from the chaotic signal generator to amplitude-modulate the chaotic signal.

4. The chaotic signal transmitter according to claim 1, wherein the waveform converter blocks a high frequency component of the transmission signal to convert the waveform of the transmission signal.

5. The chaotic signal transmitter according to claim 4, wherein the waveform converter comprises a low pass filter.
